(19) United States
(12) Patent Application Publication
(10) Pub. No.: US 2020/0147859 A1
(43) Pub. Date: May 14, 2020

(54) FULL GLUE SCREEN PROTECTOR APPLICATION DEVICE FOR CURVED SCREEN MOBILES

(71) Applicant: Rubiao Zhou, Guangzhou (CN)

(72) Inventor: Rubiao Zhou, Guangzhou (CN)

(21) Appl. No.: 16/188,543

(22) Filed: Nov. 13, 2018

(51) Int. Cl. B29C 63/02; B29C 63/00; B29C 65/56

(52) U.S. Cl. CPC B29C 63/02; B29C 63/0004; B29L 2031/3437; B29C 2063/0008; B29C 65/56

(57) ABSTRACT

A screen protector application device including a holder frame having an upper surface, a lower surface, and travel slots. A head grip protrudes from the upper surface of the holder frame at a first end. Side guides protrude from the upper surface of the holder frame along the sides. A sliding foot includes a foot grip protruding from the upper surface of the holder frame at a second end and sliding legs slidably disposed within the travel slots. At least one spring biases the sliding foot towards the head grip. The device further includes a track and an applicator. The applicator includes a handle, a roller rotatably coupled to the handle, and a slide. The slide is slidably engaged with the track such that the applicator slides along a length the holder frame with the roller disposed above the upper surface of the holder frame.

### BACKGROUND OF THE INVENTION

The present invention relates to screen protectors and, more particularly, to a screen protector application device.

A screen protector is an additional sheet of material, commonly polyurethane or glass, that can be attached to the screen of an electronic device and protect it against physical damage. Plastic screen protectors cost less than glass and are thinner but glass resists scratches better than plastic and feels more like the device's screen. Glue or other adhesives are typically used to adhere screen protectors to electronic devices. Attaching the screen protector is currently a meticulous process that must be done carefully to prevent misalignment.

As can be seen, there is a need for an improved screen protector application device.

### SUMMARY OF THE INVENTION

In one aspect of the present invention, a screen protector application device comprises: a holder frame comprising an upper surface, a lower surface, and travel slots; a head grip protruding from the upper surface of the holder frame at a first end; a side guide protruding from the upper surface of the holder frame; a sliding foot comprising a foot grip protruding from the upper surface of the holder frame at a second end, and sliding legs slidably disposed within the travel slots; at least one spring biasing the sliding foot towards the head grip; a track; and an applicator comprising a handle, a roller rotatably coupled to the handle, and a slide, wherein the slide is slidably engaged with the track such that the applicator slides along a length the holder frame with the roller disposed above the upper surface of the holder frame.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is a perspective view of an embodiment of the present invention;

FIG. 3 is an exploded view of an embodiment of the present invention;

FIG. 4 is a section view of the present invention, taken along line 4-4 in FIG. 2;

FIG. 5 is a section view of the present invention, taken along line 5-5 in FIG. 2;

FIG. 6 is a section view of the present invention, taken along line 6-6 in FIG. 5;

FIG. 7 is a section view of an embodiment of the present invention, illustrating the movement of a sliding foot grip to fit a phone; and

FIG. 8 is a section view of an embodiment of the present invention, illustrating the movement of a handle to rotate a roller over a screen protector.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

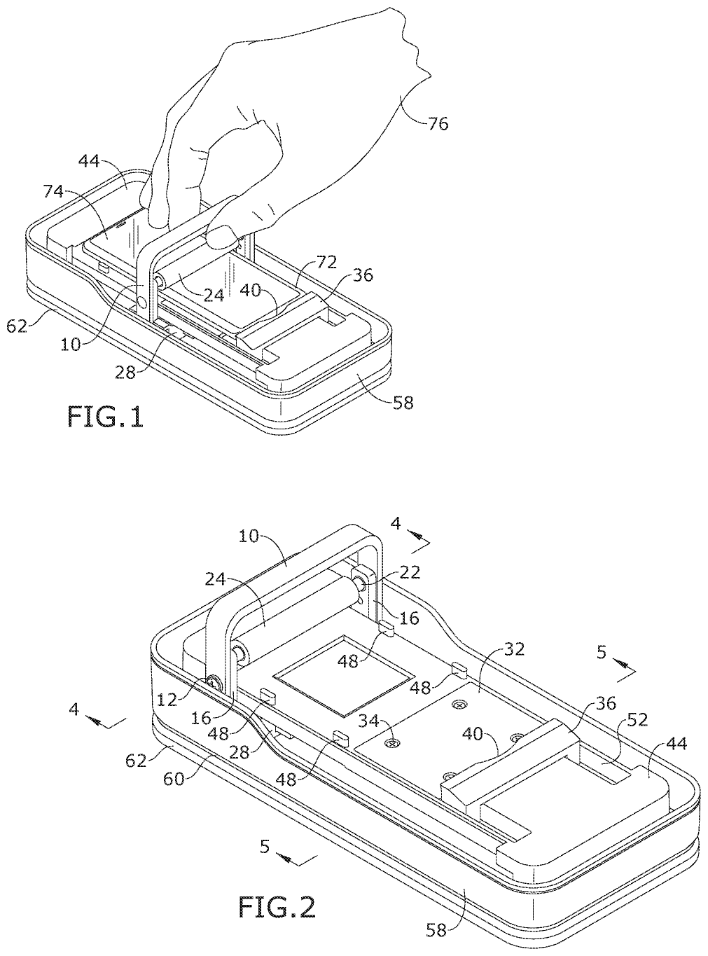

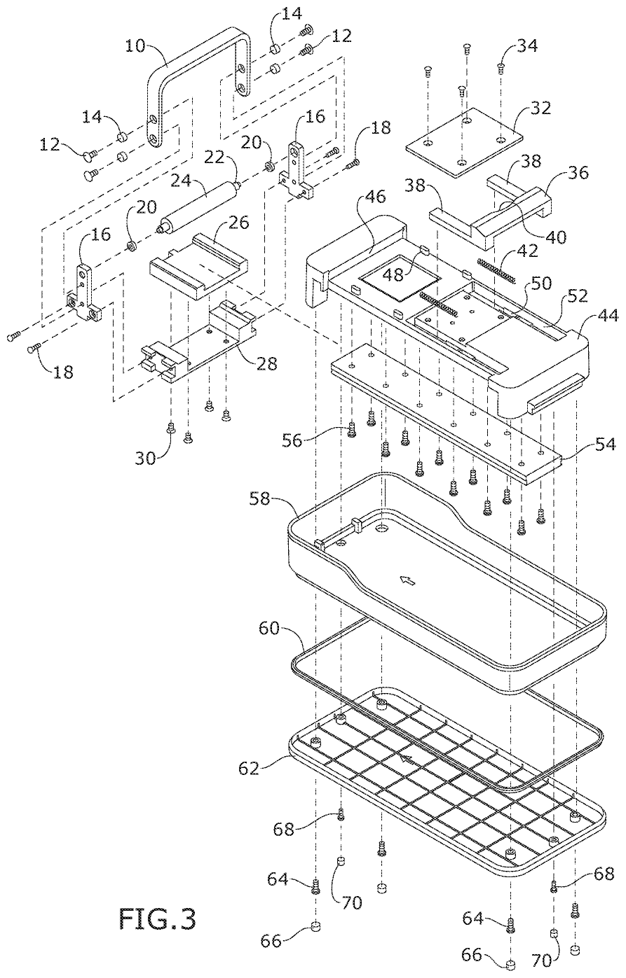

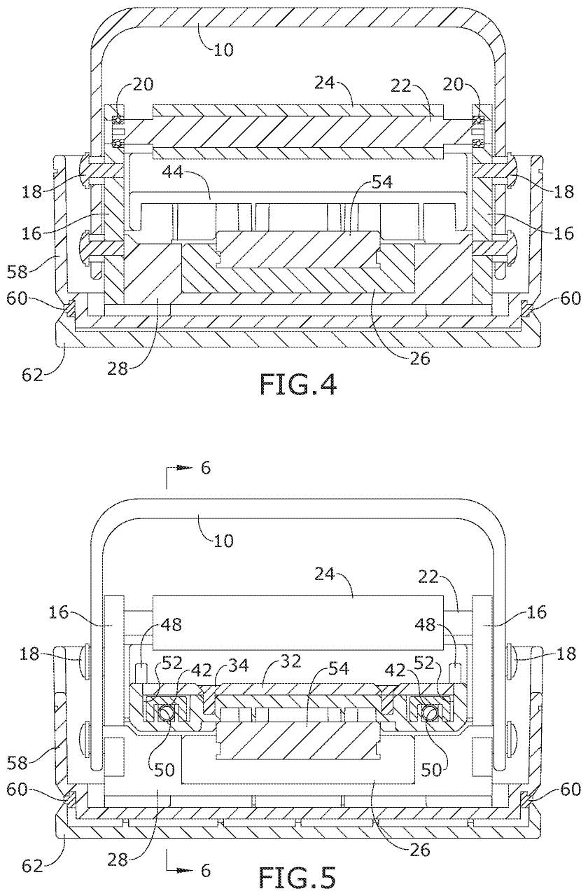

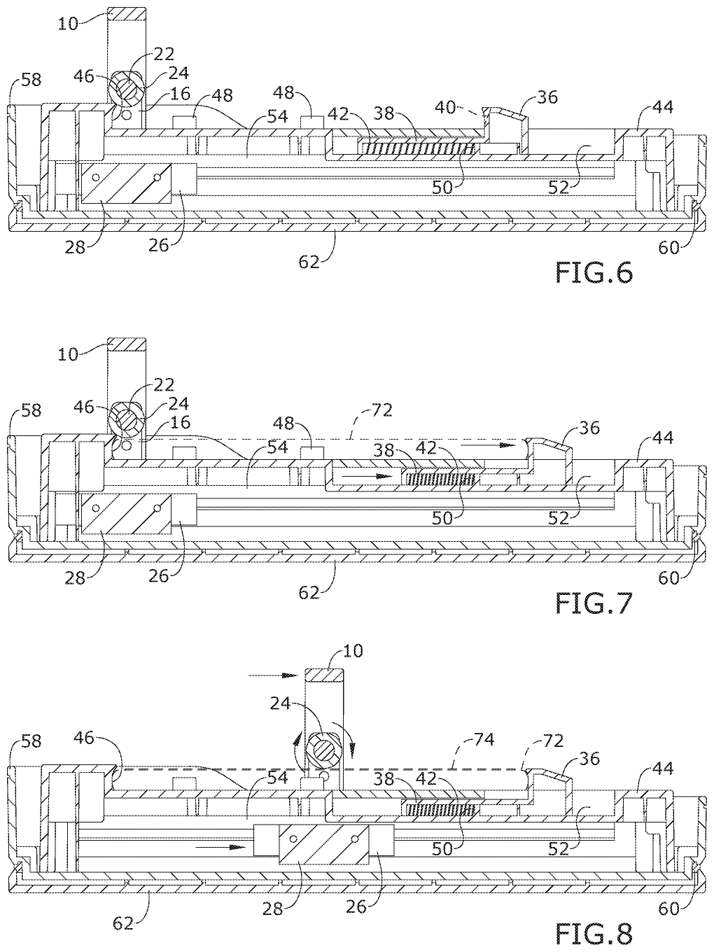

Referring to FIGS. 1 through 8, the present invention includes a screen protector application device. A holder frame 44 includes an upper surface, a lower surface, and travel slots 52. A head grip 46 protrudes from the upper surface of the holder frame 44 at a first end. Side guides 48 protrude from the upper surface of the holder frame 44 along the sides. A sliding foot 35 includes a foot grip 36 protruding from the upper surface of the holder frame 44 at a second end and sliding legs 38 slidably disposed within the travel slots 52. At least one spring 42 biases the sliding foot 35 towards the head grip 46. The device further includes a track 54 and an applicator 11. The applicator 11 includes a handle 10, a roller 24 rotatably coupled to the handle 10, and a slide 26. The slide 26 is slidably engaged with the track 54 such that the applicator 11 slides along a length the holder frame 44 with the roller 24 disposed above the upper surface of the holder frame 44.

In certain embodiments, the present invention further includes a base frame 57. The base frame 57 includes a lower shell 62, an upper shell 58, and a molding 60. The molding 60 is disposed in between the upper shell 58 and the lower shell 62. The lower shell 62 is coupled to the upper shell 58 by large screws 64 and small screws 68. Large plugs 66 may cover the large screws and small plugs 70 and may cover the small screws 68. The base frame 57 may support the holder frame 44 on a surface, when in use. The holder frame 44 may be coupled to the upper shell 58 by the large screws 64.

As mentioned above, the holder frame 44 includes a head grip 46 and side guides 48. The head grip 46 and side guides 48 center the phone 74 on the upper surface of the holder frame 44 so that the phone 74 is in the correct position for application. The sliding foot 35 slides along a length of the holder frame 44 so that the foot grip 36 is adjusted to accommodate different sized phones 72. The foot grip 36 may further have a finger slot 40 so that a user 76 may place their finger within the finger slot 40 and pull the foot grip 36 away from the head grip 46 against the bias of the spring 42.

As mentioned above, the sliding legs 38 are slidably disposed within the travel slots 52 of the holder frame 44. Spring slots 50 may be disposed within the travel slots 52. A pair of springs 42 may each couple to the spring slots 50 such that the springs 42 are disposed in between ends of the sliding legs 38 and the spring slots 50. In certain embodiments, the travel slots 52 are defined on the upper surface of the holder frame 44. A retainer plate 32 is coupled within a recess of the upper surface of the holder frame 44 and covers the travel slots 52 with the springs 42 and the spring slots 50 disposed therein. The retainer plate 32 may be coupled to the holder frame 44 by screws 34.

The applicator 11 may further include a roller frame 28 and roller arms 16 and the handle 10 may further include a U-shape. The slider 26 is coupled to the roller frame 28 by screws 30. The roller arms 16 are coupled to opposing sides of the roller frame 28 by screws 18. The U-shaped handle 10 is coupled to the roller arms 16 by screws 12 and sleeves 14. In such embodiments, the roller 24 is rotatably coupled to the roller arms 16. The roller 24 may be rotatable coupled to the roller arms 16 by a roller spindle 22 and roller bearings 20. In certain embodiments, the track 54 is coupled to the bottom of the holder frame 44 by screws 56. The slide 26 slidably engages and slides along the track 54.

The present invention may be used for phones 74 that have curved edges. To use the invention, the sliding foot 35 is pulled back and the phone 72 is placed on the upper surface of the holder frame 44 in between the head grip 46 and the side guides 48. The sliding foot 35 is then released such that the foot grip 36 presses against the phone 72 due to the springs 42 and the phone 72 is fixed in between the guides 48 and the head and foot grips 36, 46. The protector 74, such as tempered glass, and glue are placed on the screen on the phone 72. The handle 10 is grasped and pulled such that the slide 26 slides along the track 54. The roller 22 rolls over the protector 74 and thereby aligns and applies the protector 74 to the screen of the phone 72. The present invention improves upon the accuracy and the force applied to the protector 74 and the phone 74.

It should be understood, of course, that the foregoing relates to exemplary embodiments of the invention and that modifications may be made without departing from the spirit and scope of the invention as set forth in the following claims.

What is claimed is:

1. A screen protector application device comprising:
a holder frame comprising an upper surface, a lower surface, and travel slots;
a head grip protruding from the upper surface of the holder frame at a first end;
a side guide protruding from the upper surface of the holder frame;
a sliding foot comprising a foot grip protruding from the upper surface of the holder frame at a second end, and sliding legs slidably disposed within the travel slots;
at least one spring biasing the sliding foot towards the head grip;
a track; and
an applicator comprising a handle, a roller rotatably coupled to the handle, and a slide, wherein
the slide is slidably engaged with the track such that the applicator slides along a length the holder frame with the roller disposed above the upper surface of the holder frame.

2. The screen protector application device of claim 1, wherein the track is coupled to the lower surface of the holder frame.

3. The screen protector application device of claim 1, wherein the handle is a U-shape.

4. The screen protector application device of claim 3, wherein the applicator further comprises a roller frame and roller arms, wherein the slider is coupled to the roller frame and the roller arms couple the U-shaped handle to the roller frame.

5. The screen protector application device of claim 4, wherein the roller is rotatably coupled to the roller arms.

6. The screen protector application device of claim 5, wherein the roller is rotatably coupled to the roller arms by a roller spindle and roller bearings.

7. The screen protector application device of claim 1, further comprising spring slots disposed within the travel slots, wherein the at least one spring is a pair of springs each coupled to the spring slots such that the springs are disposed in between ends of the sliding legs and the spring slots.

8. The screen protector application device of claim 7, wherein the travel slots are defined on the upper surface.

9. The screen protector application device of claim 8, further comprising a retainer plate coupled within a recess of the upper surface of the holder frame and covering the travel slots with the springs and the spring slots disposed therein.

10. The screen protector application device of claim 1, wherein the foot grip comprises a finger groove.

11. The screen protector application device of claim 1, further comprising a base frame, wherein the holder frame is coupled to the base frame.

12. The screen protector application device of claim 11, wherein the base frame comprises an upper shell coupled to a lower shell, wherein the holder frame is coupled to the upper shell.
